(19) United States
(12) Patent Application Publication
(10) Pub. No.: US 2019/0291636 A1
(43) Pub. Date: Sep. 26, 2019

(54) Driverless Vehicle Warning Device

(71) Applicants: Lonnie Gillery, Southfield, MI (US); Mark Gillery, Southfield, MI (US)

(72) Inventors: Lonnie Gillery, Southfield, MI (US); Mark Gillery, Southfield, MI (US)

(21) Appl. No.: 15/936,062

(22) Filed: Mar. 26, 2018

(51) Int. Cl. B60Q 1/50

(52) U.S. Cl. CPC B60Q 1/50

(57) ABSTRACT

Disclosed is a driverless vehicle warning device. The device is mounted on vehicles which are capable of driverless operation. The device emits a light signal indicating whether the vehicle has a live driver.

### FIELD OF THE INVENTION

This invention relates generally to warning devices, particularly vehicular warning lights.

### BACKGROUND OF THE INVENTION

Light has been used since the dawn of civilization as a means of communication. With the advent of the light bulb and electricity, the use of lighting to communicate the status of persons and things has expanded exponentially. The world is now inhabited by a multitude of machinery that communicates operational status with lights, including warning lights that convey machinery breakdowns and hazardous conditions. Automobiles in particular have long contained a system of lights to communicate vehicle status. Turn signals indicate a change in direction. Flashers signify operational failure or diminished vehicle capacity. Brake lights warn other drivers of a vehicle slowdown. With the advent of driverless cars, there is a need for warning lights that inform the public whether a vehicle is being driven by a person or by a computer.

### SUMMARY OF THE INVENTION

This invention is designed to advance the use of vehicular light systems by creating a warning light device that informs the public whether or not a car has a live driver.

### BRIEF DESCRIPTION OF DRAWINGS

FIG. 1 is a side view of the invention, showing a rectangular box with a light system.

FIG. 2 is a front view of the invention.

### DETAILED DESCRIPTION OF INVENTION

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail beyond the particular implementation choices shown. That is, there are numerous modifications and variations of the invention that are too numerous to be listed, but that all fit within the scope of the invention. Also, singular words should be read as plural, and vice versa, and masculine as feminine, and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or,” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

Although Claims have been formulated in this Application to particular combinations of features, it should be understood that the scope of the disclosure of the present invention also includes any novel feature, or any novel combination of features, whether or not it relates to the same invention as presently claimed in any Claim, and whether or not it mitigates any or all of the same technical problems as does the present invention.

Features which are described in the context of separate embodiments may also be provided in combination in a single embodiment. Conversely, various features which are, for brevity, described in the context of a single embodiment may also be provided separately or in any suitable sub-combination. The Applicants hereby give notice that new Claims may be formulated to such features, or combinations of such features, during the prosecution of the present Application, or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art, many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, improved or optimized by those skilled in the art, using their average skills and known techniques, to achieve the desired implementation that addresses the needs of the particular application.

The present invention will now be described.

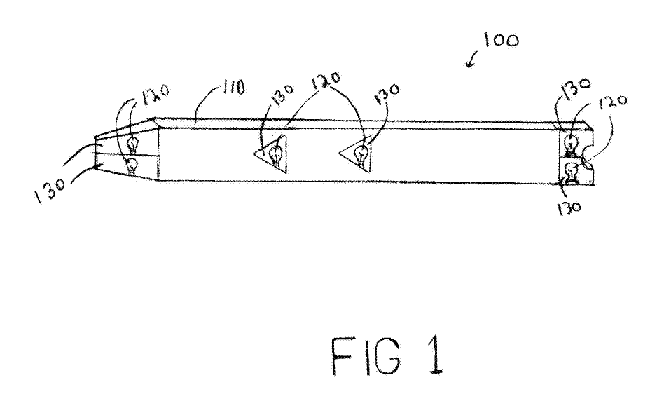

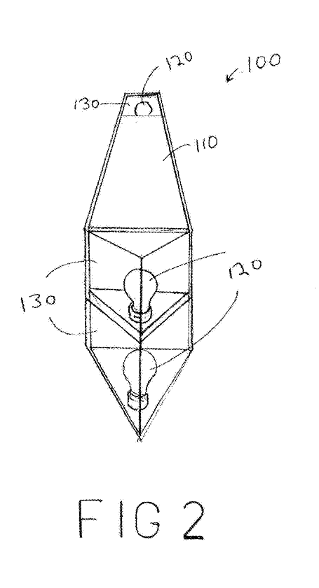

The invention is best understood by reference to the drawings, FIGS. 1-2. FIG. 1 shows the device 100 from one side: a housing 110, here in the form of a rectangular box, with a light source 120 capable of signaling two distinct colors at various locations on the housing 110. One color signifies that the vehicle has a live driver, and the other color signifies that the vehicle is driverless. The light color is created by the radiation frequency of the light source 120 itself and transmitted through a translucent window 140, or the translucent window 140 can be tinted to signal the color. FIG. 1 also shows the mirror image of its opposite side, thus insuring that the light signals are broadcast evenly from both sides of the vehicle. FIG. 2 is the device 100 from the front, showing a light source 120 within a translucent window 130 at both front and rear.

The invention is subject to a wide range of embodiments. The housing of the device can be almost any shape or size provided the light source is clearly visible to pedestrians and other drivers. There is currently no color standard to signal the driver status of a driverless capable vehicle, but the signal colors of the device would conform to such a standard once it exists. Another embodiment of this invention would be a translucent bubble, like that of a taxi-cab or old-style police car, which broadcasts a light signal in all directions from a single light source.

In an embodiment, the invention is connected to the vehicle's computer, or an equivalent system, such that the device is informed whether the vehicle is operating without a live driver, translating that information into the appropriate light signal. In an embodiment, the invention is mounted on the roof of a vehicle, where it is most easily visible. In another embodiment, multiple devices are connected at multiple places on a vehicle, such as the corners, where the signals are visible from all angles. This latter embodiment is particularly suitable for convertibles where the roof is not a suitable mounting platform. Another embodiment uses the light source to illuminate a graphic indicating the vehicle's driver status, such as a driver crossed with a circled “X,” or a driver not crossed with a circled “X.”

What is claimed:

1. A driverless vehicle warning device, comprising:
(a) a housing, comprising an inner space and a containment wall.
(b) a light source, situated within the housing, said light source comprising a plurality of light bulbs capable of radiating a light signal at two visibly distinct light frequencies,
(c) a means to power the light source,
(d) a means to inform the light source whether the vehicle has a live driver, and to translate that information to power the light source at one of the two visibly distinct light frequencies.

2. The claim as in 1, wherein
(a) the housing is a rectangular structure, comprising a left side, a right side, a front end, and a back end, and
(b) the light source comprises four bulb sets, each bulb set comprising two light bulbs, each bulb set affixed to and made visible from the right side, the left side, the front end, and the back end of the housing.

3. The claim as in 1, wherein the housing is translucent.

4. The claim as in 1, wherein a graphic is illuminated to signal the vehicle's driver status.

5. The claim as in 1, wherein the driverless vehicle warning device is mounted on the roof of a vehicle.

6. The claim as in 1, wherein a plurality of the driverless warning device are connected to a vehicle at each corner.

7. The claim as in 1, wherein the light source blinks in a pattern to signal the vehicle's driver status.

8. A method of using the driverless warning device, comprising:
(a) assigning a meaning to light color to represent whether a driverless capable vehicle is being operated with or without a driver, and
(b) broadcasting the light signal based on driver status for interpretation by other drivers and pedestrians.

9. The claim as in 8, wherein driver status is signaled by an illuminated graphic.

10. The claim as in 8, wherein driver status is signaled by a light source blinking pattern.
